(19) United States
(12) Patent Application Publication
(10) Pub. No.: US 2011/0135247 A1
(43) Pub. Date: Jun. 9, 2011

(54) Fiber Splice Housing

(75) Inventors: Chinedu Onyema Achara, London (GB); Mladan Todorov, Welling Kent (GB)

(73) Assignee: SENSORNET LIMITED, Elstree (GB)

(21) Appl. No.: 13/057,195

(22) PCT Filed: Aug. 7, 2008
(86) PCT No.: PCT/GB2008/050675

§ 371 Date: Feb. 2, 2011

(51) Int. Cl. G02B 6/00; B23P 11/00

(52) U.S. Cl. 385/12; 385/135; 29/428

(57) ABSTRACT

Splicing optical fibers from cables running along an infrastructure involves passing the cables into a housing (80) having space to contain a fiber splice (100) and contain an additional length of slack fiber extending around a bend of at least 180 degrees, or a number of coils, in a substantially annular plane. After splicing, the fiber splice and slack fiber are placed in the housing, which is sealed to resist pressures of at least 200 psi, and the assembly is fixed to the infrastructure. The space in the housing can enable the housing to be used for protecting U-bends or to provide some slack fiber within the housing. This can enable faster onsite splicing operations or allow for rework without needing to relocate and strip more cable, to save costs. The housing can be suitable for fitting in the annular space between production tube and casing for use in sensing down boreholes.

### FIELD OF THE INVENTION

The present invention relates to fiber splice assemblies, to housings for such assemblies and to methods of splicing using such housings, and to methods of sensing using such assemblies.

### BACKGROUND

There is a requirement in industry for the measurement of conditions such as strain or temperature and other conditions at all points over long distances. Typical uses are for monitoring oil and gas wells, long cables and pipelines. The measurements can be displayed or analysed and used to infer the condition of the structures. Distributed temperature sensors (DTS) often use Raman or Brillouin components of scattered light in optical fibers as the means to determine the temperature. Here, light from an optical source is launched into a fiber and the small amount of light that is scattered back towards the source is analysed. By using pulsed light and measuring the returning signal as a function of time, the backscattered light can be correlated to distance along the fiber. This backscattered light contains a component which is elastically scattered (Rayleigh light) and components that are up- and down-shifted in frequency from the source light (Raman and Brillouin anti-Stokes and Stokes light respectively, also known as inelastic scattered light). The powers of the returning Raman components are temperature dependent and so analysis of these components yields the temperature. The powers and frequency of the returning Brillouin components are strain and temperature dependent and so analysis of both components can yield temperature and strain independently. Such systems have been known for many years. Raman back scattering analysis is discussed, for example, in U.K. Patent Application 2,140,554, published November, 1984, which is hereby incorporated by reference in its entirety.

A typical optical fiber is composed of a core within a layer of cladding and thereafter one or more buffer layers. The core provides a pathway for light. The cladding confines light to the core. The buffer layer provides mechanical and environmental protection for both core and cladding. A typical single-mode fiber (SMF) is composed of precision extruded glass having a cladding with a diameter of 125 μm+−2 μm and a core with a diameter of 8 μm+−1 μm at a centre of the cladding. The buffer layer is typically composed of a flexible polymer applied onto the outer surface of a cladding. Most commercial fibers are manufactured with a buffer layer of a polymer coating. With special polymer materials such as polyimide, these types of fiber can offer good performance up to 300° C. in normal atmosphere. It is known that fiber optic cables can deteriorate in harsh environments such as those encountered in down-hole fiber optic sensing applications. As discussed in U.S. Pat. No. 6,404,961, down-hole environmental conditions can include temperatures in excess of 130° C., hydrostatic pressures in excess of 1000 bar, vibration, corrosive chemistry and the presence of high partial pressures of hydrogen. To protect optical fibers from the effects of hydrogen, hermetic coatings and barriers, such as carbon coatings and the like have been used to minimize the effects of hydrogen.

It is known to monitor temperature and pressure using fiber optic Distributed Temperature Sensors (DTS) which have the ability to take measurements every lm with a resolution of less than 1° C. A known method of installation for the fiber optics is to install a ¼″ control line inside the well and to “pump” the fibers into the control lines. It is also known from WO/2003/098176 to provide a downhole sensing system using fiber sensing cable and Raman backscattering analysis, with the cable being attached to a production tube. The cable can be affixed to the production tube by adhesives, by strapping, by wrapping, or by physical integration with the tube. The cable can be installed by clamping the cable to the pipe as it is placed in the well, e. g. using well-known collar protectors used in the oil and gas industry. Calibration sensors may each be installed within splice sleeves. This is accomplished by cutting the cable, fusion splicing optical calibration sensor (e. g., fiber Bragg gratings FBGs) to either end of the calibration fiber protruding from the ends of cut cable using well-known fiber optic cable splicing techniques, splicing any other fibers or wires within the cable, e. g. a sensing fiber, and sealing the splice(s) and sensor within the splice sleeve. The splice sleeve may comprise a ⅜ inch metal tube welded onto a ¼ inch metal sheath of the cable. Where the cable does not have a metal sheath, the sleeve may comprise a snap sleeve or heat shrink sleeve capable of providing a hermetic seal. U.S. Pat. No. 6,435,030, discloses a housing for sensors coupled to the production tube, and which is incorporated by reference in its entirety.

### SUMMARY OF THE INVENTION

It is an object of the present invention to provide improved apparatus and methods. According the first aspect of the invention there is provided:

A housing for protecting a fiber splice between optical fibers from one or more cables running along tubular infrastructure, the housing comprising at least one port for passing one or more cables carrying the fibers into the housing, and an arrangement for attaching the housing to the infrastructure, the housing having space to contain a fiber splice coupling at least one of the optical fibers from the one or more cables and being suitable to fit within an annular space between substantially cylindrical surfaces of the infrastructure having a separation of less than 0.15 m, the housing being sealable to resist pressures of at least 200 psi, the housing extending further in an annular direction than in a radial direction and enclosing a space suitable to guide an additional length of at least one of the fibers round at least 180 degrees in a substantially annular plane.

Unlike the known splice protecting sleeves, the provision of space in the housing for at least a bend of fiber can enable the housing to be used for protecting U-bends or to provide some slack fiber within the housing for example. Providing space for slack fiber has a number of advantages such as enabling faster onsite splicing operations as will be explained in more detail below. Faster onsite splicing operations can result in major cost savings. For example where the infrastructure is downhole pipework, and the splicing operation must be carried out on a rig floor during a pause in insertion of the pipework, the cost of such a pause may be measured in tens of thousands of dollars or more per hour.

Another aspect of the invention provides a spliced fiber cable assembly comprising one or more cables carrying optical fibers along a tubular infrastructure, the assembly having such a housing enclosing a fiber splice and a bend of the fiber.

Another aspect provides:

A method of splicing optical fibers from one or more cables running along an infrastructure, the method having the steps of:

passing the one or more cables into a housing, the housing also having space to enclose a fiber splice and and suitable to guide an additional length of at least one of the fibers round at least 180 degrees in a substantially annular plane,

splicing at least one of the optical fibers from the cables,

placing the fiber splice in the housing,

sealing the housing to resist pressures of at least 200 psi, and

attaching the assembly to the infrastructure.

Another aspect provides a corresponding method of sensing using the fiber splice assembly, and involving launching light along the fiber, receiving light from the fiber and deducing conditions along the fiber from the received light.

Any additional features can be added to any of the aspects. Other advantages will be apparent to those skilled in the art, especially in relation to other prior art not known to the inventors. Any of the additional features can be combined together and combined with any of the aspects, as would be apparent to those skilled in the art.

### BRIEF DESCRIPTION OF THE DRAWINGS

Embodiments of the invention and how to put it into practice are described by way of example with reference to the accompanying drawings in which:—

FIG. 1 shows a schematic view of fiber splicing equipment at a rig floor at a well head

FIG. 2 shows a cross section plan view of a housing on a production tubing according to an embodiment of the present invention,

FIG. 3 shows a cross section view on A-A according to the embodiment of FIG. 2,

FIG. 4 shows a three quarter exploded view of an embodiment of a housing,

FIG. 5 shows a cross section view of a port according to an embodiment,

FIG. 6 shows a side view of a splicing rig for use in an embodiment,

FIG. 7 shows a plan view of the rig of FIG. 6,

FIG. 8 shows steps in a splicing method according to an embodiment,

FIG. 9 shows a three quarter view of a housing according to another embodiment,

FIGS. 10, 11 and 12 show cross sectional views of different arrangements of islands.

### DETAILED DESCRIPTION

Definitions:

References to a housing can encompass housings of various sizes or shapes, housings formed of a main body, a lid and a part for attaching, or other parts, or being a one-piece item, with the part for attaching being integral with the main body. The housing can be one-time sealable, or resealable many times. They can be of metal or other materials.

References to an assembly can encompass parts preassembled, or parts assembled on site.

References to an arrangement for attaching the housing can encompass any type of fixing, including straps for strapping, clamps of any sort, clamps for clamping the cable to a pipe using well-known collar protectors, as the pipe is placed in a well. Attaching can be by wrapping, by welding, by adhesives, or by physical integration with the tube, or any other way. If the clamp fits around a tube, then the clamp can be arranged to follow the shape of the tube and the main body part need not do so. If the attaching part is a bolt and a corresponding hole in the main body for example, then the main body part can follow the shape of the tube to make a good fit.

References to ports can encompass sealable holes, resealable holes, holes of any shape, sealable in any way, or recesses in a joint between parts of a housing for example.

References to a substantially annular plane can encompass a plane following a substantially cylindrical surface. This can also encompass a flat plane such as a tangential plane subtending an angle of less then 90° such that the extent of the plane still remains within the annular space between two substantially cylindrical surfaces. References to non corrosive metals can encompass alloys such as Incoloy 825, stainless steels such as SS 316 and others.

Introduction to Embodiments

By way of introduction to the embodiments, some of the problems of protecting fibers such as sensing fibers and fiber splices in harsh environments will be discussed briefly.

The useful life of the fiber in such environments depends on countering three major causes of deterioration: glass oxidation or other glass deterioration at high temperature, hydrogen ingress and physical damage during installation. The protective fibre coating can have a simultaneous effect on some or all of these in that the coating prevents exposure of the surface of the glass of the fiber to oxidation or other deterioration in such high temperatures. Various protective coatings can substantially prevent hydrogen ingress and also protect the glass from physical damage. Increasing the useful life can help reduce costs of replacing fibers in locations such as bore holes. Different protective coatings are used depending on the temperature and environmental conditions of a particular installation.

Cables to protect the sensing fibers can take a number of configurations. For example a fiber or fibers can be surrounded by a metal conduit. This may be a stainless steel strip wrapped around the fiber and welded. Another example is an Al tube, which can provide good hydrogen ingress resistance at high temperatures. It may have insulating and or hydrogen protective coatings on inside and/or outside surfaces of the conduit, and may be filled with a hydrogen scavenging gel. The metal may be surrounded by a second metal conduit, with a filler material in between. This can help avoid transfer of stresses to the fiber which could interfere with measurements. A further outer encapsulation layer of for example HDPE can be provided to give abrasion protection. It is often good practice to install two fibres within a cable for both redundancy, and to enable different calibration techniques. It will often be necessary to connect the two fibres together at the far end of the cable. It is common to do this using a fusion splice. Splices are often regarded as a source of failures.

A high-quality fusion splice is often measured by two parameters:

i. Splice loss and

ii. Tensile strength

For graded-index multimode fibers, the fiber related factors include core diameter mismatch, numerical aperture (NA) mismatch, index profile mismatch, core/cladding concentricity error and cladding diameter mismatch. Splice process-related, factors are those induced by the splicing methods and procedures. Splice process factors include lateral and angular misalignment, contamination and core deformation. Fiber preparation includes fiber stripping, surface cleaning and fiber-end angle.

At least some of the embodiments of the invention as described below show a housing for a spliced fiber cable assembly of cables carrying optical fibers along an infrastructure, the assembly being fixable to the infrastructure and the housing comprising at least one port for passing into the housing one or more cables carrying the fibers. The housing has space for protecting a fiber splice coupling at least one of the optical fibers from the cables and space for protecting an additional length extending around a bend of at least 180 degrees, of at least one of the fibers, the housing being sealable to resist pressures of at least 200 psi.

Additional Features:

Embodiments of the invention can have any features added to those mentioned above. Some notable additional features will be described and some are the subject of dependent claims. Many others can be envisaged. The housing can have a curved outside face to fit against the outside of tubing, or the inside of casing for use down boreholes or in undersea structures or other harsh environments. The housing can have overall dimensions suitable to fit within an annular space between cylindrical surfaces. One example is the movable tubing and fixed or movable casing in a borehole, other examples can be envisaged such as above ground structures or tubes or pipework. The housing can have internal islands surrounded by channels for spooling slack fiber around the islands. The islands can provide support for a lid to cover the channels. The housing can be manufactured from different materials to provide protection against corrosion, such as SS 316 and Incoloy 825, or others. The housing can be formed to withstand pressures of up to 5000 psi, or 10,000 psi, or 15,000 psi for example, to suit different environments. In one example the housing can provide enough space to coil at least 0.3 m of fibre. This can be enough to enable the fibre ends to reach the splicer from the housing, or to be reworked after an unsatisifactory splice. The housing can provide enough space to allow many turns or coils of fiber to be housed within This means they can be used to protect a coil of reference fiber, which may be spliced into the cable at a known position corresponding to a known depth of borehole for example. This is useful for deep wells, to improve collected data.

The ports provided to allow the cables to enter the internal space, and allowing pressure sealing to be achieved to the cables, can be arranged to be resealable. There can be ports arranged at both ends of the housing to enable the cable to extend beyond the housing, or there can be a port or ports at only one end of the housing where it is for the end of a cable. In some examples, four cables can be jointed in the housing.

A pressure test port can be provided to allow pressure testing of a port before assembly, and also after assembly, to confirm pressure resistance of the housing and the cables, to reduce a number of failures.

The housing can have a lid and gasket allowing it to be pressure sealed. A test arrangement can be provided to test the lid seal.

The housing can extend in an annular shape to fit around part or all of the circumference of a pipe. It may extend around an angle of anything up to 360°.

The housing can be used at the end of a cable(s) or in-line at a mid-point (above a packer etc), and may be inserted in any point of a previously installed cable for the purpose of inserting instrumentation or repairing a damaged cable if required.

A splicing rig may be provided to hold the housing in place close to splicing tools, during splicing at the infrastructure location. Such specialised arrangement of tools can minimize time and improve quality of the splices in difficult locations such as a rig floor. The ports may be used to clamp the cables during splicing. Cable ends can be stripped to bare sufficient fiber to enable the ends of the fibers to be moved to a splicer without unclamping the cables. After splicing, the slack fiber can be coiled in the housing.

A main body of the housing can be secured to the tubing using bands or clamps, of conventional design or clamps adapted specially for the housing. The body and any clamps or straps of the housing can be sufficiently low in profile to fit in the annular space between the production tubing and the casing. The housing can be filled with hydrogen scavenging gels if required. The housing can be arranged to work with cables having other components such as electrical supply lines (FOC+EL), and the housing can be used additionally for protecting electrical equipment or sensors.

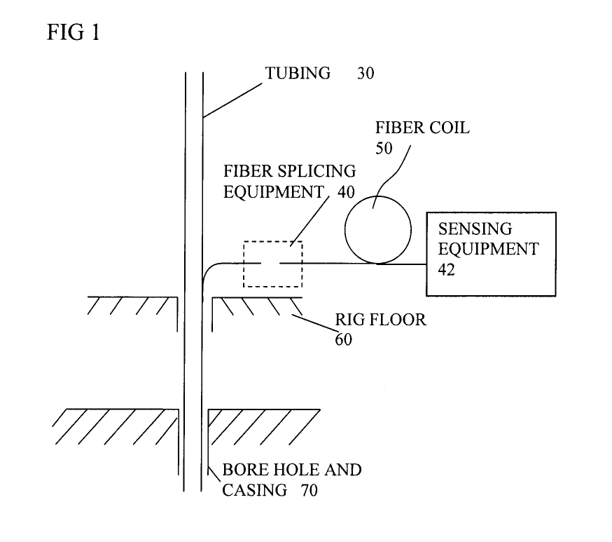

FIG. 1, Fiber Splicing Equipment at a Rig Floor at a Well Head

FIG. 1 shows a schematic view of fiber splicing equipment at a rig floor at a well head. Other applications are of course conceivable. In this case a borehole and casing 70 are shown, with a rig floor 60 above, which may be part of an offshore or onshore rig for example. Other parts such as a derrick and insertion mechanisms are not shown for the sake of clarity. Infrastructure along which the cable runs is shown in the form of tubing 30, though other such infrastructure can be envisaged. The tubing may be for example production tubing, and is shown being inserted or extracted from the borehole. A fiber contained in a cable is being attached or detached from the production tubing as it is being lowered or raised respectively, taken from or being spooled onto a fiber coil 50. Fiber splicing equipment 40 is provided nearby on the rig floor. When the fiber is installed and used for sensing, equipment 42 for launching and receiving optical signals into or from the fiber can be provided on the rig floor, using devices following established practice which need not be described in more detail here.

The fiber splicing equipment can be used for example to couple a new section of cable, or to insert sensors or anything else into the optical path in mid cable, or to terminate the cable. A U-bend may be inserted at the lower end of the cable for example.

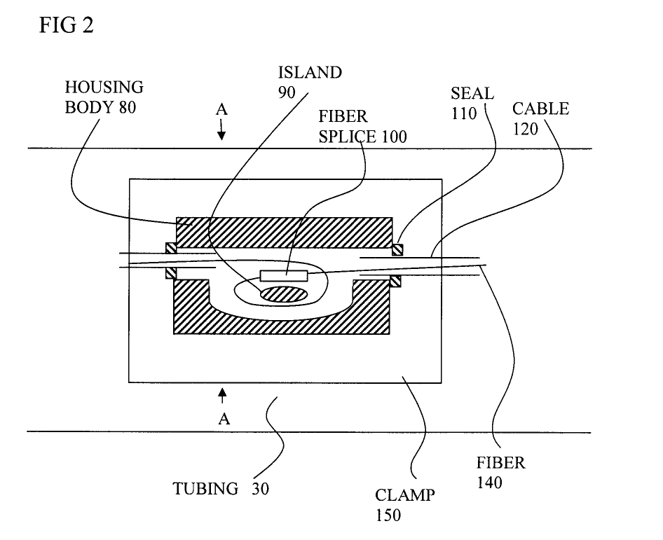

FIG. 2, Housing on a Production Tubing

FIG. 2 shows a cross section plan view of a housing on a tube such as production tubing, for protecting a fiber splice. The housing has a main body 80 which has ports at each end and a central space for enclosing the fiber splice 100 and a coil of fiber. An island is provided around which the slack fiber can be coiled. The space can be made large enough to accommodate just a few coils, perhaps half a meter or so, to provide slack to enable the splice to be made outside the housing and then moved into the housing. Or enough space can be provided for hundreds of coils, to enable many meters of fiber to be coiled, for example to enable a section of reference fiber to be protected within the housing. There can be more than one fiber splice if desired. An island 90 is shown, around which the fiber may be coiled. There can be many islands. The islands may be useful for supporting a lid (not shown). The lid may be detachable to enable the fiber splice and coil to be placed in the space in the housing. Or the lid may be at other locations, for example at either end, to enable the splice and slack fiber to be slid in and sealed. A seal 110 is shown at each port for sealing a gap between the cable 120 surrounding the fiber 140 as it extends along the infrastructure such as the production tubing 30. Of course this is applicable to other types of infrastructure such as overground pipes, bridges, dams or others.

An arrangement for attaching is shown in the form of a clamp 150, shown fitting over the main body of the housing to attach the main body to the tubing 30. This can involve any type of attachment including bands, bolts, adhesives, mechanisms to couple to joints in the production tubing and so on. Many configurations are possible. The clamp may be integrated with the housing, or be a separate item.

Although the ports are shown at the ends and off centre, they could be at other locations, or there could be just one port. Having the ports off centre provides a straighter path for the fiber to join the perimeter of the coiling space.

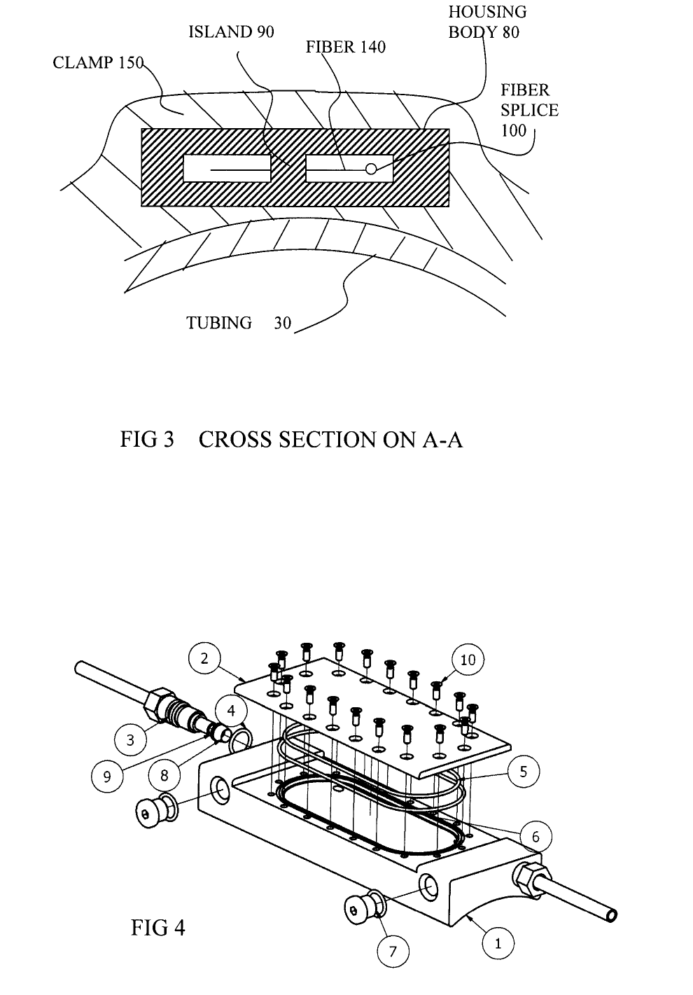

FIG. 3, Side View of Housing

FIG. 3 shows a cross section view on A-A according to the embodiment of FIG. 2. This shows an end view of the tubing, and the clamp 150 having a curved lower face to fit the tubing. The main body 80 of the housing has a rectangular outline, or if desired it could have a curved lower face to fit the curve of the tubing. Likewise the top face could be shaped to follow an inside curve of cylindrical surface such as a casing of a borehole. The island is shown reaching to a lid or cover of the space of the housing, to support this cover or lid.

FIG. 4, Three Quarter Exploded View of Another Assembly

FIG. 4 shows a three quarter exploded view of another embodiment of parts of a housing. The housing comprises a main body 1, typically machined from a corrosion resistant metal, and a lid 2 to cover a central space. Gaskets 5 and 6 and bolts 10 are provided to seal the lid onto the main body. Seals are provided for the ports at each end of the main body. One seal is shown in a sealed position, the other in an exploded view. The exploded one shows a sealing ring 4, a tapered part 8 for fitting a corresponding tapered aperture in the main body, and a part 9 having a thread 3, for engaging with a corresponding thread on the aperture, to force the tapered parts together to create a good seal between cable and main body of the housing. At the same time the sealing ring 4 will be located outside the threaded part to provide a second seal, compressed between the main body and a large head of the part 9. Also shown are pressure test valves 7 for providing access to internal parts of the seal to enable the seal to be tested before the assembly is installed in inaccessible places. No islands are shown in this embodiment, which enables more flexibility in use of the space, but may mean that the lid will not withstand so much pressure, or will need to be reinforced.

FIG. 5, Port

FIG. 5 shows a cross section view of a port for use in the embodiment of FIG. 4 or in other embodiments. Many other sealing arrangements can be envisaged, either resealable or permanent, such as welding metal to metal, or using adhesive for example. The cable 120 carrying the fiber 140 enters an aperture in the housing body as shown, to enable the fiber to reach the space inside the main body of the housing, shown at the bottom of this view. The seal has a threaded main part 820 sealed to the cable by a ring seal 810. The thread 850 of this part engages with thread 860 of the aperture and is tightened to force the main part downwards against tapered part 870. This forces the tapered part downwards into the corresponding tapered part of the aperture to form a seal between the aperture of the housing and the outer face of the cable. A further ring seal 830 is provided to seal the gap above the thread, as a precaution. This seal can be compressed by the head of the main part, or be arranged to fit in a recess in parts 1 and or 820, and be compressed by external pressure to create a seal for example.

A passage 840 can be provided for testing the seal. This passage can extend into both gaps above the tapered part as shown. Testing the seals can involve injecting fluid into this passage and inspecting for leakage at the exterior of the main body of the housing at rings 830 and 810, and optionally checking for leakage into the housing past the tapered part. In some cases, the sensing will be affected by leakage and so can be used to detect failed seals, either during testing or later in operation.

Cable

The cable is intended to protect the optical fiber or fibers, and enable a good seal with the housing. An example is a multi-layer cable, to provide the protection required for downhole installations in oil wells. Other examples can be envisaged. A basic cable might have a single stainless steel tube surrounding carbon polyimide coated fibers in a hydrogen scavenging gel. For more protection a double wall or tube in tube type can be used. An example specified for operation within the −40° C. to 150° C. temperature range, will be described in more detail. Two fibres are included in the cable allowing for double ended measurements. An inner tube of 304 SS or other metal, has a diameter of approximately 3.2 mm, and wall thickness of 0.2 mm. This can be filled with a hydrogen scavenging gel for example. This is surrounded by a belting of polypropylene of thickness 0.2 mm to provide separation from an outer tube of 316 SS or other metal. This outer tube has a diameter of 6.3 mm and wall thickness of 0.7 mm approx. An outer encapsulation can be of Santoprene or other materials such as HDPE of outer diameter 11 mm and thickness of 3.9 mm approx.

To create a good seal the outer encapsulation can be stripped back to enable a metal on metal compression seal for example.

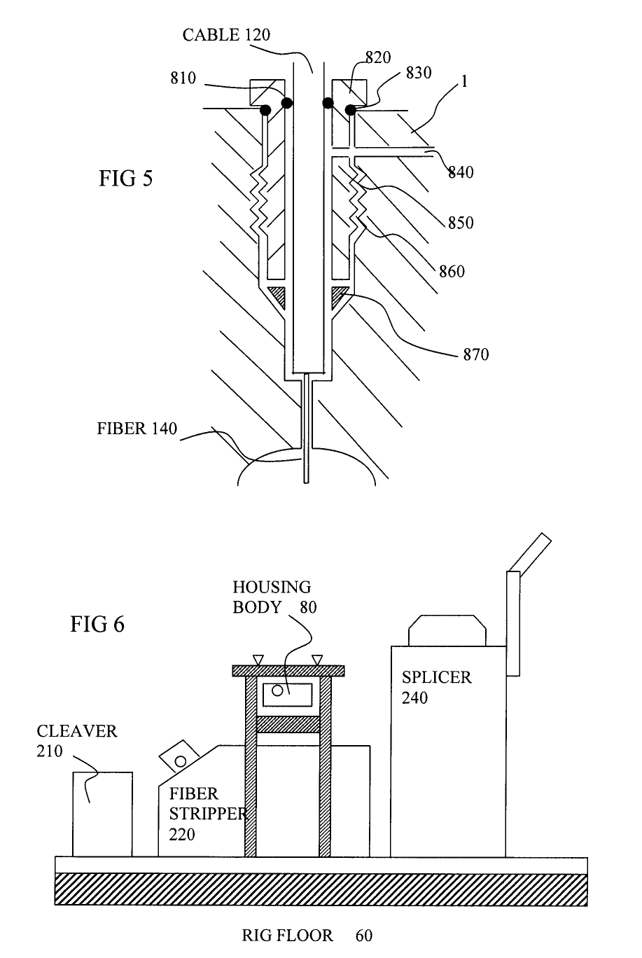

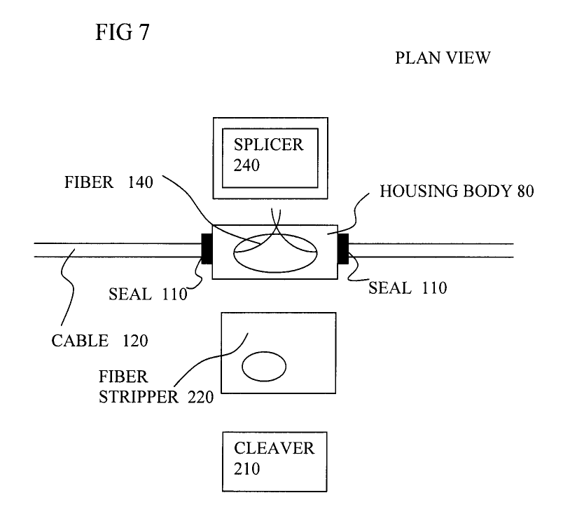

FIGS. 6 and 7, Splicing Rig

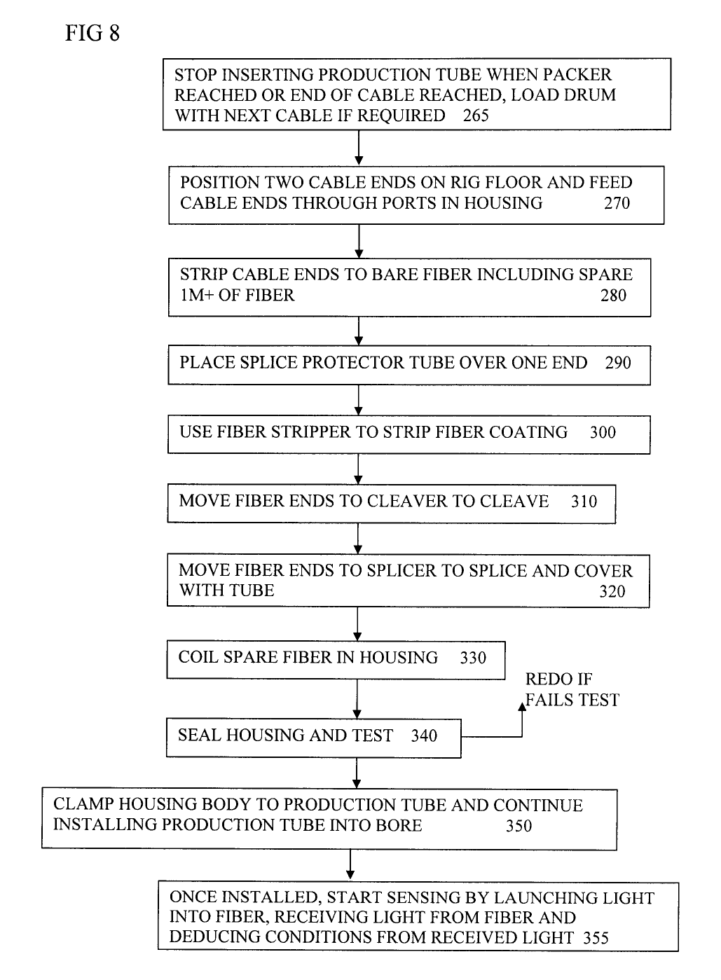

FIG. 6 shows a side view of a splicing rig for use in an embodiment. This shows a rig floor 60, a table, shown hashed, for supporting the housing body 80 of the housing, optionally with clamps for gripping the body of the housing. A cleaver 210 is provided close by, and a fiber stripper 220, and a fusion splicer 240. These can be implemented using conventional technologies and need not be described here in more detail. They can be ruggedised as appropriate if the rig is in a harsh environment such as arctic, desert or offshore environments. The purpose of the rig is to enable fiber splicing to be carried out next to the well head where the production tubing is moved in or out of the bore, as will be described in more detail with reference to FIG. 8.

FIG. 7 shows a plan view of the rig of FIG. 6. This shows schematically the position of the housing which can be clamped to the table. The cables to be joined can be clamped either to the body of the housing or to the table for example, to provide stress relief. The splicer, fiber stripper and cleaver are shown close to the housing so that the ends of the fibers can be moved easily to the various tools. The locations can be varied, and the housing could be arranged to be slidable laterally towards each of the tools, if there was some slack in the cables.

FIG. 8, Method of Splicing.

FIG. 8 shows steps in a splicing method according to an embodiment. This is described for the case of connecting and splicing a new length of cable when installing a sensing fiber, though other cases can be envisaged such as splicing a U-bend or splicing in a reference section of fiber and so on. At step 265, the operator stops inserting the production tube at a given location, for example the position of a production packer, or when the end of the current cable is reached. The operator then positions two cable ends on the table on the rig floor and feeds ends of the cables through the ports in the housing at step 270. Then the operator strips the cable ends to bare fiber including a spare 0.5 or 1 m or so of fiber, at step 280. The operator can choose to clamp the cable ends in the ports to provide strain relief during the splicing. To achieve a good seal the encapsulation should be stripped back so that there can be a metal to metal seal. This sealing can of course be left to be completed later after the splicing.

As a preliminary to the splicing, the operator places a splice protector tube over one of the ends to be spliced at step 290. The operator then uses the fiber stripper to strip the fiber coating at step 300. The fiber ends are then moved to the cleaver to cleave the ends at step 310. Then the cleaved ends are moved to the splicer to splice and the splice is then covered with the protective tube at step 320.

The step of stripping the fiber can involve removing any outer protective coatings to leave the cladding exposed at the ends to be joined. This can be done by chemical, thermal or mechanical treatment for example. The next steps can involve the ends being cleaved, aligned and fused. Conventional fusion equipment can be used. The uncoated gap of approximately 30 mm length is now covered by the protective tube. The protective tube might be a polymer based splint that is heat shrunk around the uncoated fusion splice. Alternatively, for higher temperatures, protective sleeves of other materials such as high temperature polymers or ceramics can be used. Epoxy or ceramic paste might be used to seal the protective tube in place over the fibre fusion splice region. The end splice protector has a length of up to approximately 40 mm. After coiling the spare fiber and the protected splice in the space in the body of the housing at step 330, the housing can be sealed and tested at step 340. If the test fails, the housing can be opened up again and resealed. The splice may also be tested and if necessary can be remade. The housing can then be clamped to the production tube and the operator can continue installing the production tube into bore with the cable and housing attached, at step 350. Once installed, sensing can start by launching light into fiber, receiving light from fiber and deducing conditions from received light at step 355.

For the case that the housing is as shown in FIG. 4, the steps of the method could include assembling the parts of the seals including O-rings and tapered parts, onto the cables, then inserting the cables into the aperture and tightening the seals. Before splicing, the connections are pressure tested e.g. to 8,000 psi for ten minutes, and a visual check made for leakage. The test connections can be removed and the test passage plugged. The splicing operation can be as set out above. After splicing, the slack fiber is laid in the space in the body of the housing, and hydrogen scavenging gel used to fill the space in the housing. Gaskets can be fitted to the lid area, and the lid can be fitted and tightened. In some embodiments the gaskets can be tested in similar fashion to the test of the seals in the ports. The housing is then ready to be attached to the production tubing, e.g. by clamps used to cover the joints in the production tube.

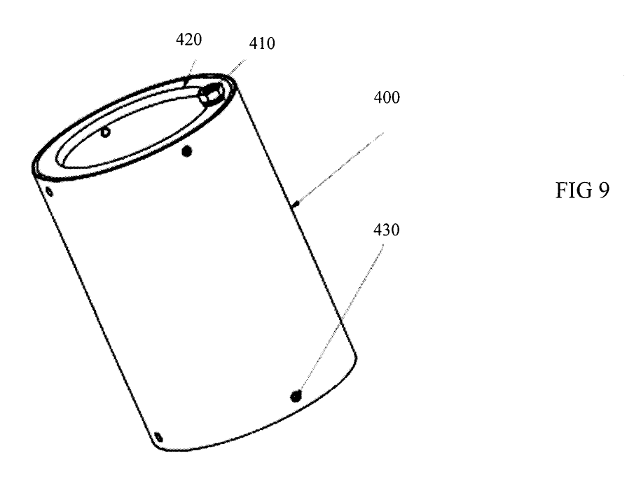

FIG. 9, Cylindrical Housing

FIG. 9 shows a three quarter view of a housing according to another embodiment. In this case, the housing is cylindrical and so encloses a space which extends circumferentially all round the tube to which it is to be fitted. In some cases a bolt or similar arrangement can be used to engage the tube or joints in the tube, to prestrain the cylindrical body from sliding along the tube. The body can be formed of an outer shell 400 and an inner shell which is only partially visible at the top of the figure. A lid to close the space is shown by circular part 420 at the top of the figure. A similar part can be provided at the bottom, held by bolts 430. Typically gaskets are provided to ensure a good seal of the lid. Optionally, further bolts can be provided to fasten the lid in an axial direction rather than, or as well as the radial bolts as shown. A port 410 is shown in the lid, with a seal which can be similar to the seal shown in FIG. 4. Another port can be provided in the base of the housing, if desired, out of view.

Various ways of clamping such a housing to the production tubing or other cylindrical parts can be envisaged. Some embodiments can be arranged for clamping to an inside surface of a tube rather than the outside. The slack fiber can be bent or coiled in the circumferential space inside the housing.

In other embodiments, the housing can be rectangular, and attached by a standard clamp used at the joints in the production tubing, to protect the cable over the joint where there are variations in diameter.

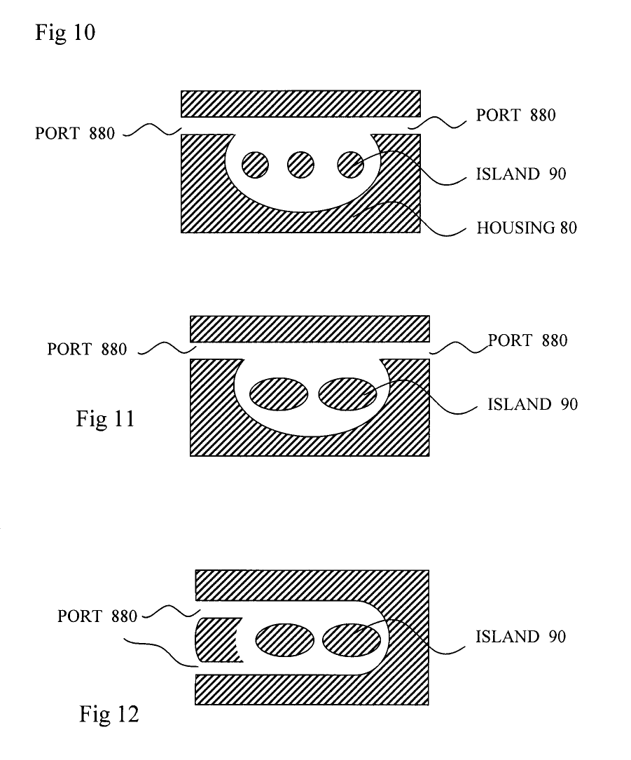

FIGS. 10 to 12, Islands

These figures show cross sectional views of different arrangements of islands and ports. In FIG. 10, ports 880 are shown at either end, and off centre, and three islands 90 are provided. This provides multiple different paths for bending or coiling the slack fiber. FIG. 11 shows a similar arrangement of ports, but two larger islands. This should provide better support for the lid, but fewer paths for the fiber. FIG. 12 shows a further arrangement with ports 880 both at the same end, and off centre. Two islands are shown. Embodiments with one port can be envisaged, for use with a U-bend, or housings can have three or four ports for example. Some ports can be blocked off if not needed.

Advantages of Housings Having Space for Fiber Bend

A number of advantages can arise, such as for example:

a) The space in the housing for at least a bend can enable some slack in the fibers after splicing, which can be bent, or in some cases coiled, in the housing. This can in some cases enable multiple attempts at a splice without having to restrip the cable. Or it can enable larger tolerances in the location of the stripping and cutting of the fiber ends for splicing. At least in the case that any of these advantages enables a splicing operation at the location of the infrastructure to be made easier, more reliable or quicker, this can result in major cost savings. For example where the infrastructure is downhole pipework, and the splicing operation must be carried out on a rig floor during a pause in insertion of the pipework, the cost of such a pause may be measured in tens of thousands of dollars or more per hour.

The additional length of slack fibre can make it easier to allow more space for work between splicer and cassette. The spare fiber means that the cables can be sealed to the assembly providing strain relief during the splicing operation.

b) The space for a bend can enable the housing to be used to protect a U-bend of fiber to enable a return path of fiber to enable bidirectional launch of light for sensing, or other uses.

c) In some cases where there is space in the housing for coils of longer lengths of fibre, then the housing can be used to contain a length of reference fiber which will be at similar temperature, to act as a reference section in subsequent measurements.

d) The housing could be used for additional sensors or electrical equipment. These can be located in the islands for example. Electrical equipment can be powered by an electrical supply line running alongside the fibers in the cable.

Concluding Remarks

Some or all of the measures or features described can be combined to enable robust sensing installations, including the protection of splices in the sensing cable. Other variations within the claims can be conceived.

1. A housing for protecting a fiber splice between optical fibers from one or more cables running along tubular infrastructure, the housing comprising at least one port for passing one or more cables carrying the fibers into the housing, and an arrangement for attaching the housing to the infrastructure, the housing having space for enclosing a fiber splice coupling at least one of the optical fibers from the one or more cables and being suitable to fit within an annular space between substantially cylindrical surfaces of the infrastructure having a separation of less than 0.15 m, the space of the housing being sealable to resist pressures of at least 200 psi, the housing extending further in an annular direction than in a radial direction and being suitable to guide an additional length of at least one of the fibers round at least 180 degrees in a substantially annular plane.

2. The housing of claim 1, the housing having at least one curved face to fit against at least one of the substantially cylindrical surfaces.

3. The housing of claim 1, the space being sufficiently large for spooling slack fiber within the housing.

4. The housing of claim 3, having a sealable lid to cover the space, and having internal islands providing support for the lid.

5. The housing of claim 1, being of a non corrosive metal and able to withstand pressures of greater than 5000 psi.

6. The housing of claim 1, the port providing a resealable seal between the cable and the housing.

7. The housing of claim 6, the port having a pressure test port to allow pressure testing of the port.

8. A spliced fiber cable assembly comprising one or more cables carrying optical fibers along a tubular infrastructure, the assembly having a housing comprising at least one port for passing into the housing one or more cables carrying the fibers, the housing enclosing a fiber splice coupling at least one of the optical fibers from the one or more cables and an additional length, bending around at least 180 degrees, of at least one of the fibers, in a substantially annular plane and the housing being sealable to resist pressures of at least 200 psi, and the assembly having an arrangement for attaching the housing to the infrastructure within an annular space between substantially cylindrical surfaces of the infrastructure having a separation of less than 0.15 m.

9. The assembly of claim 8, the housing having at least one curved face to fit against at least one of the cylindrical surfaces.

10. The assembly of claim 8, the housing having sufficient space for spooling slack fiber within the housing.

11. The assembly of claim 10, having a sealable lid to cover the space, and the space having islands providing support for the lid.

12. The assembly of claim 8, the housing being of a non corrosive metal and able to withstand pressures of greater than 5000 psi.

13. The assembly of claim 8, having at least 0.3 m of fiber coiled within the housing.

14. The assembly of claim 8, the port providing a resealable seal between the cable and the housing.

15. The assembly of claim 14, the port having a pressure test port to allow pressure testing of the port.

16. A method of splicing optical fibers from one or more cables running along an infrastructure, the method having the steps of:
passing the one or more cables into a housing, the housing also having space to enclose a fiber splice and and suitable to guide an additional length of at least one of the fibers round at least 180 degrees in a substantially annular plane,
splicing at least one of the optical fibers from the cables,
placing the fiber splice in the housing,
sealing the housing to resist pressures of at least 200 psi, and
attaching the assembly to the infrastructure.

17. The method of claim 16 having the step of making a resealable seal between the cables and the housing.

18. The method of claim 16, having the step of clamping the cables to the housing before the splicing.

19. The method of claim 16, having the step of stripping sufficient fiber to provide at least 0.3 m of additional length, and after splicing, coiling the additional length in the housing.

20. The method of claim 17, having the step of testing the sealing of the cables before the attaching step.

21. The method of claim 16, the attaching involving attaching the housing to tubing for insertion into a borehole.

22. The method of claim 16, the step of splicing involving splicing a reference section of fiber to the fiber from the cable, and coiling the reference section within the housing.

23. A method of sensing using a spliced fiber cable assembly, the assembly comprising one or more cables carrying optical fibers along a tubular infrastructure, the assembly having a housing comprising at least one port for passing into the housing one or more cables carrying the fibers, the housing enclosing a fiber splice coupling at least one of the optical fibers from the one or more cables and an additional length, bending around at least 180 degrees, of at least one of the fibers, in a substantially annular plane and the housing being sealable to resist pressures of at least 200 psi and the housing extending further in an annular direction than in a radial direction, and the assembly having an arrangement for attaching the housing to the infrastructure within an annular space between substantially cylindrical surfaces of the infrastructure having a separation of less than 0.15 m, the method having the steps of launching light along the fiber, receiving light from the fiber and deducing conditions along the fiber from the received light.
